(19) United States
(12) Patent Application Publication
(10) Pub. No.: US 2026/0011940 A1
(43) Pub. Date: Jan. 8, 2026

(54) QUICK CONNECTION STRUCTURE AND METHOD FOR YARN CONDUCTIVE WIRE AND CIRCUIT BOARD

(71) Applicants: NEXTRONICS ENGINEERING CORP., NEW TAIPEI CITY (TW); MAKALOT INDUSTRIAL CO., LTD., Taipei City (TW)

(72) Inventors: HOU-AN SU, KEELUNG CITY (TW); KUAN-WEN CHEN, NEW TAIPEI CITY (TW); YU-TING SUN, Keelung City (TW); WEI-YI TSAI, Taipei City (TW); LI-XIANG LEE, Taipei City (TW)

(21) Appl. No.: 18/945,547

(22) Filed: Nov. 13, 2024

(30) Foreign Application Priority Data
Jul. 4, 2024 (TW) 113125028

(51) Int. Cl. H01R 12/62; H01R 12/65

(52) U.S. Cl. CPC H01R 12/62; H01R 12/65

(57) ABSTRACT

Quick connection structure and method for a yarn conductive wire and a circuit board are provided. The quick connection structure includes at least one yarn conductive wire, at least one fork-shaped terminal, and the circuit board. One end of the fork-shaped terminal has a fork portion. At least one mounting hole is formed on the circuit board, and the mounting hole penetrates two opposite sides of the circuit board. During assembly, the yarn conductive wire is inserted into a channel of a jig to allow the yarn conductive wire originally arranged horizontally to be arranged vertically. The fork-shaped terminal is pressed into the jig to cover the yarn conductive wire. The yarn conductive wire and the fork-shaped terminal are pressed into the mounting hole of the circuit board. A material tape of a row of the fork-shaped terminal is removed along a break line of the fork-shaped terminal.

### CROSS-REFERENCE TO RELATED PATENT APPLICATION

This application claims the benefit of priority to Taiwan Patent Application No. 113125028, filed on Jul. 4, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a quick connection structure and method for a yarn conductive wire and a circuit board, and more particularly to a connection structure and method that can connect a yarn conductive wire to a circuit board and be used for electrical signal transmission.

### BACKGROUND OF THE DISCLOSURE

A yarn conductive wire is made of a yarn and a metal wire wound in a spiral manner, and has the characteristics of stretchability and conductivity. If the yarn conductive wire is applied to fabric, signals from various parts of the body can be transmitted to a device center for processing without losing the stretchability of the fabric, allowing the yarn conductive wire to be used in products such as functional clothing. Generally, a connection of electrical signals between different carriers is achieved by soldering, where a metal medium is added between conductors to transmit electrical signals. However, the spinning yarn is not resistant to high temperatures, and when electrical signal transmission is required, it is necessary to develop a new and quickly implementable connection method.

### SUMMARY OF THE DISCLOSURE

In response to the above-referenced technical inadequacies, the present disclosure provides a quick connection structure and a quick connection method for a yarn conductive wire and a circuit board, so as to connect and fix the yarn conductive wire and the circuit board without using solder and be environmentally-friendly. Furthermore, the quick connection structure and method can be used to process materials that are not resistant to high temperature, and can achieve effects of convenient and fast for being used in mass production.

In order to solve the above-mentioned problems, one of the technical aspects adopted by the present disclosure is to provide a quick connection structure. The quick connection structure includes at least one yarn conductive wire, at least one fork-shaped terminal, and a circuit board. One end of the fork-shaped terminal has a fork portion, the fork portion is bifurcated, and an accommodation space is defined in the fork portion. At least one mounting hole is formed on the circuit board, the mounting hole penetrates two opposite sides of the circuit board, and a wire diameter of the yarn conductive wire is smaller than a diameter of the mounting hole. The yarn conductive wire is accommodated in the accommodation space of the fork-shaped terminal, the fork portion of the fork-shaped terminal and the yarn conductive wire are pressed into the mounting hole of the circuit board, and the fork portion of the terminal and the mounting hole of the circuit board form an interference fit. The yarn conductive wire is clamped in the fork portion of the fork-shaped terminal, so that the yarn conductive wire is connected and fixed to the circuit board.

In order to solve the above-mentioned problems, another one of the technical aspects adopted by the present disclosure is to provide a quick connection method for a yarn conductive wire and a circuit board. The quick connection method includes: providing at least one yarn conductive wire, at least one fork-shaped terminal, and a circuit board, in which one end of the fork-shaped terminal has a fork portion, the fork portion is bifurcated, and an accommodation space is defined in the fork portion; in which at least one mounting hole is formed on the circuit board, the mounting hole penetrates two opposite sides of the circuit board, and a wire diameter of the yarn conductive wire is smaller than a diameter of the mounting hole; accommodating the yarn conductive wire in the accommodation space of the fork-shaped terminal; and pressing the fork portion of the fork-shaped terminal and the yarn conductive wire into the mounting hole of the circuit board, so that the fork portion of the fork-shaped terminal and the mounting hole of the circuit board form an interference fit; in which the yarn conductive wire is clamped in the fork portion of the fork-shaped terminal, so that the yarn conductive wire is connected and fixed to the circuit board.

Therefore, in the quick connection structure and the quick connection method for a yarn conductive wire and a circuit board provided by the present disclosure, the quick connection structure includes at least one yarn conductive wire, at least one fork-shaped terminal, and a circuit board. One end of the fork-shaped terminal has a fork portion, an accommodation space is defined in the fork portion, at least one mounting hole is formed on the circuit board, and a wire diameter of the yarn conductive wire is smaller than a diameter of the mounting hole. The yarn conductive wire is accommodated in the accommodation space of the fork-shaped terminal, the fork portion of the fork-shaped terminal and the yarn conductive wire are pressed into the mounting hole of the circuit board, and the fork portion of the terminal and the mounting hole of the circuit board form an interference fit. The yarn conductive wire is clamped in the fork portion of the fork-shaped terminal, so that the yarn conductive wire is connected and fixed to the circuit board. Accordingly, by the guiding of the fork-shaped terminal and friction force at the outer side of the fork-shaped terminal, pressing the fork portion into the mounting hole is smooth and pulling the fork portion out of the mounting hole is difficult. That is, the fork-shaped terminal that remains in the mounting hole exerts a force of expansion providing a friction force to an inner wall of the mounting hole, thereby effectively preventing the yarn conductive wire from being pulled out. The quick connection structure and the quick connection method for a yarn conductive wire and a circuit board provided by the present disclosure can connect and fix the yarn conductive wire and the circuit board in a quick and simple assembly without using solder and be environmentally-friendly. Furthermore, the quick connection structure and method can be used to process materials that are not resistant to high temperature, and can achieve effects of convenient and fast for being used in mass production.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a perspective exploded view of a quick connection structure of a yarn conductive wire and a circuit board according to the present disclosure;

FIG. 2 is a schematic diagram of a jig for inserting the yarn conductive wire according to the present disclosure;

FIG. 3 is an exploded perspective view of the yarn conductive wire and a fork-shaped terminal according to the present disclosure;

FIG. 4 is a perspective view of the yarn conductive wire accommodated in the fork-shaped terminal according to the present disclosure;

FIG. 5 is a perspective view of the fork-shaped terminal and the yarn conductive wire pressed into mounting holes of the circuit board according to the present disclosure;

FIG. 6 is another perspective view of the fork-shaped terminal and the yarn conductive wire pressed into the mounting holes of the circuit board according to the present disclosure;

FIG. 7 is a perspective view of the fork-shaped terminal and the yarn conductive wire being pressed into the mounting hole of the circuit board and the material tape being broken according to the present disclosure;

FIG. 8 is a cross-sectional view of the fork-shaped terminal and the yarn conductive wire being pressed into the mounting hole of the circuit board and the material tape being broken according to the present disclosure; and

FIG. 9 is a flowchart of a quick connection method for the yarn conductive wire and the circuit board according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Embodiments

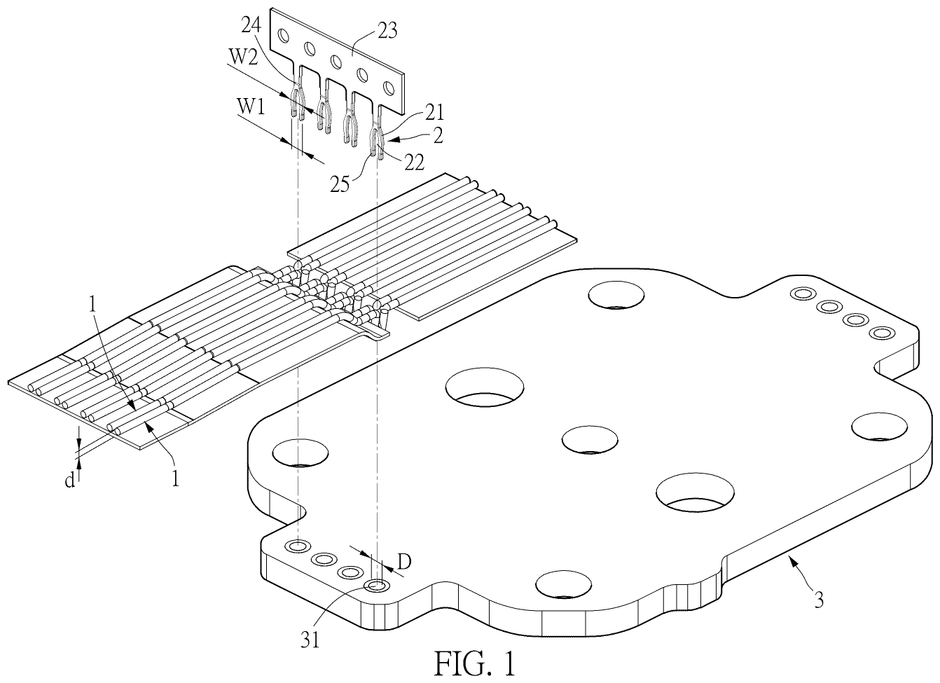

Referring to FIG. 1, the present disclosure provides a quick connection structure for a yarn conductive wire and a circuit board, and the quick connection structure includes at least one yarn conductive wire 1, at least one fork-shaped terminal 2, and a circuit board 3.

The yarn conductive wire 1 includes a yarn and a metal wire (not shown) that are wound in a spiral manner. The yarn conductive wire 1 is an extendable and conductive yarn wire structure, and has the properties of extendibility and electrical conductivity. Since the yarn conductive wire 1 is an existing technology and the present disclosure does not limit a structure of the yarn conductive wire 1, it will not be described in detail herein. The quantity of the yarn conductive wire 1 is not limited, and one or more yarn conductive wires 1 can be provided. Multiple yarn conductive wires 1 are provided in this embodiment to have a larger transmission capacity. The yarn conductive wires 1 are arranged horizontally and bonded in pairs, such that two yarn conductive wires 1 can be assembled together in a same mounting hole 31.

The fork-shaped terminal 2 is substantially in a shape of a harpoon. One end of the fork-shaped terminal 2 has a fork portion 21, and the fork portion 21 is bifurcated. An accommodation space 22 is defined in the fork portion 21 and can be used to accommodate the yarn conductive wire 1.

Preferably, a width of the accommodation space 22 tapers inward, such that the yarn conductive wire 1 can be gradually clamped when being placed in the accommodation space 22 to have better fixing and conduction effects.

The fork portion 21 can be connected to a material tape 23. A break line 24 is disposed between the fork portion 21 and the material tape 23 (as shown in FIG. 1). The fork-shaped terminal 2 is connected to the material tape 23, such that the fork-shaped terminal 2 is driven by the material tape 23 to be assembled on the circuit board 3. After the fork portion 21 of the fork-shaped terminal 2 and the yarn conductive wire 1 are pressed into the mounting hole 31 of the circuit board 3, the fork portion 21 and the material tape 23 can be separated by breaking along the break line 24.

A guide portion 25 can be formed at one end of the fork portion 21 away from the material tape 23. A width W1 of the guide portion 25 is smaller than a width W2 of the fork portion 21, and the guide portion 25 is rounded, so as to provide better guiding effect to enable the fork portion 21 of the fork-shaped terminal 2 to smoothly insert into the mounting hole 31. Multiple fork-shaped terminals 2 can be connected to one material tape 23, such that multiple yarn conductive wires 1 can be respectively mounted in multiple mounting holes 31 of the circuit board 3 simultaneously, thereby achieving mass production feasibility. Furthermore, the number of yarn conductive wires installed in mounting holes in a single installation can also be adjusted according to the number of the mounting holes 31 of the circuit board 3.

The circuit board 3 can be a flexible or rigid circuit board. At least one mounting hole 31 is formed on the circuit board 3. The mounting hole 31 can be a round hole, the mounting hole 31 penetrates two opposite sides of the circuit board 3, and the number of the mounting hole 31 is not limited. One or more mounting holes 31 may be provided in the present disclosure, and a plurality of mounting holes 31 are provided in this embodiment. The mounting holes 31 are arranged at intervals. The mounting holes 31 respectively correspond to the yarn conductive wires 1, and the mounting holes 31 can be arranged in a row to facilitate the connection and fixing of the yarn conductive wires 1.

In this embodiment, a diameter D of each of the mounting holes 31 may range from 0.7 mm to 1.1 mm, and the diameter D of the mounting hole 31 is preferably 0.9 mm. A wire diameter d of the yarn conductive wire 1 is smaller than the diameter D of the mounting hole 31. The wire diameter d of the yarn conductive wire 1 can range from 0.3 mm to 0.6 mm, and the wire diameter d of the yarn conductive wire 1 preferably ranges from 0.4 mm to 0.5 mm.

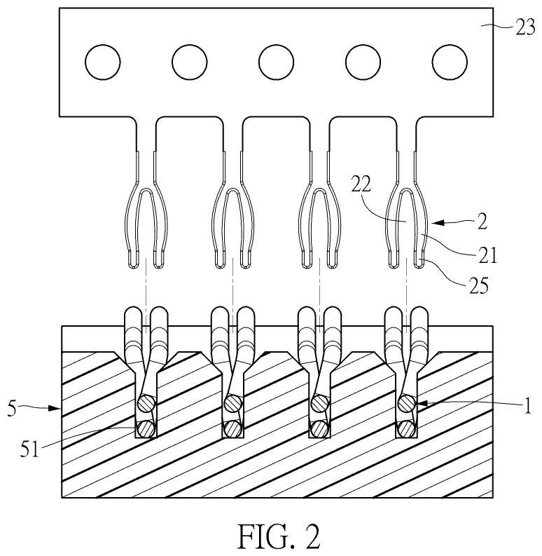

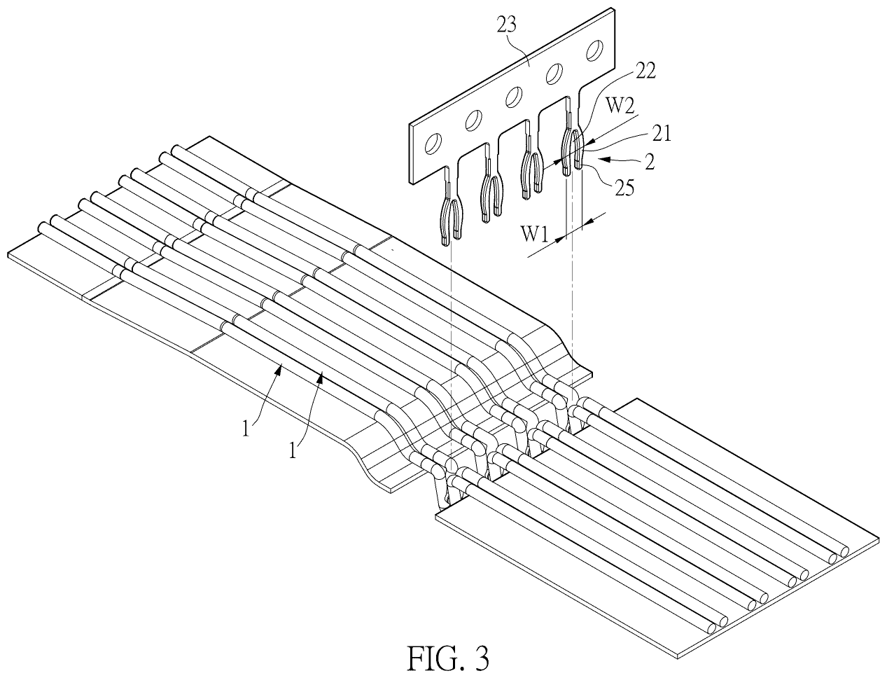

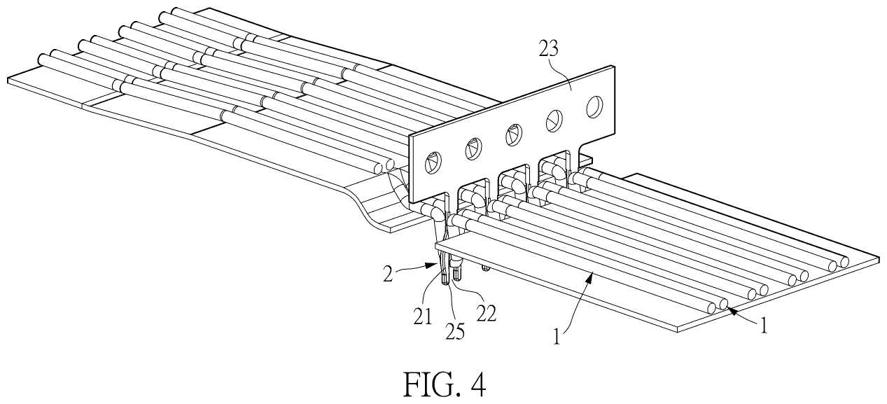

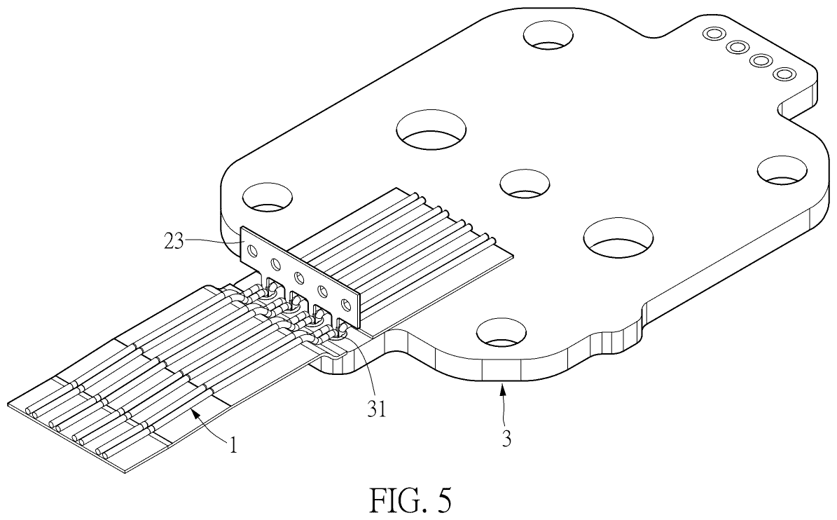

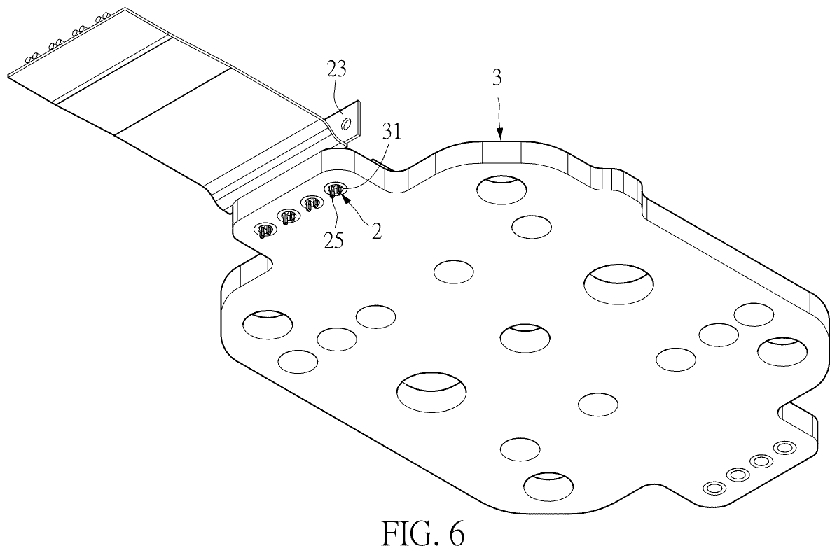

In this embodiment, multiple (for example, two) yarn conductive wires 1 can be assembled together in the same mounting hole 31. During assembly, the multiple yarn conductive wires 1 can be inserted into a channel 51 of a jig 5 beforehand (as shown in FIG. 2), so as to allow the plurality of yarn conductive wires 1 originally arranged horizontally to be arranged vertically in the channel 51 of the jig 5. The fork-shaped terminal 2 is then pressed in a top-down manner (as shown in FIG. 3 and FIG. 4), such that the yarn conductive wire 1 is accommodated in the accommodation space 22 of the fork-shaped terminal 2, and the yarn conductive wire 1 is covered by the fork portion 21 of the fork-shaped terminal 2. Accordingly, the fork portion 21 of the fork-shaped terminal 2 and the yarn conductive wire 1 are pressed into the mounting hole 31 of the circuit board 3 (as shown in FIG. 5 and FIG. 6), and the fork portion 21 of the fork-shaped terminal 2 and the mounting hole 31 of the circuit board 3 form an inference fit. By using the guiding of the fork-shaped terminal 2 and the friction force on the outside the fork-shaped terminal 2, pressing the fork portion 21 into the mounting hole 31 is smooth and pulling the fork portion 21 out of the mounting hole 31 is difficult. The inner wall of the mounting hole 31 of the circuit board 3 abuts against the fork portion 21 of the fork-shaped terminal 2, and the yarn conductive wire 1 is clamped in the fork portion 21 of the fork-shaped terminal 2, so as to connect and fix the yarn conductive wire 1 and the circuit board 3 together. In addition, the fork-shaped terminal 2 and the circuit board 3 can be further glued and fixed to achieve a more stable bonding between the fork-shaped terminal 2 and the circuit board 3.

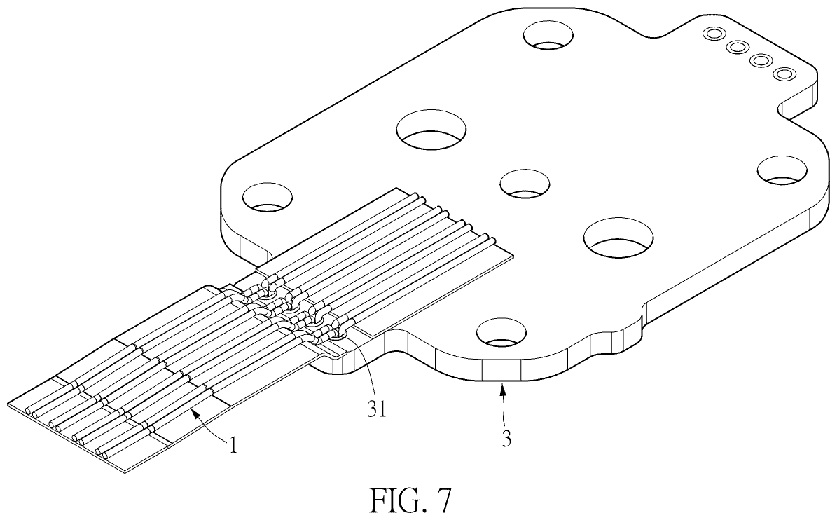

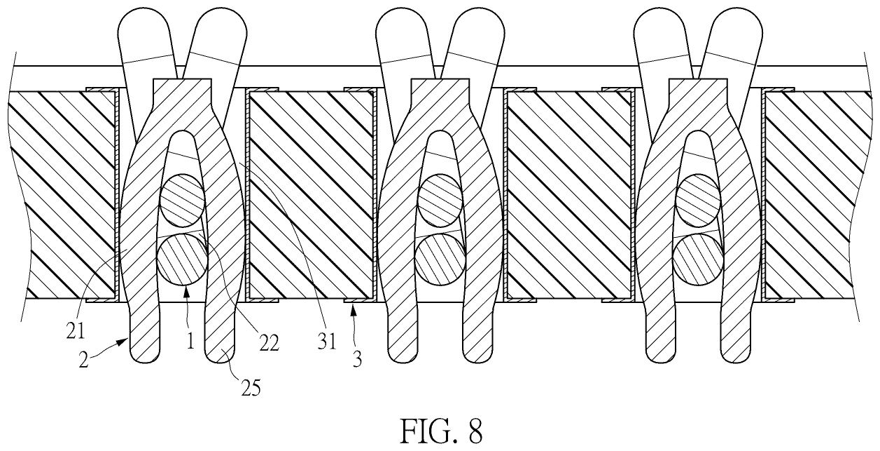

Finally, the material tape 23 of the entire row of fork-shaped terminals 2 are removed from the break line 24 of the fork-shaped terminals 2 (as shown in FIG. 7 and FIG. 8). The friction force exerted by the expansion force of the fork-shaped terminal 2 remaining in the mounting hole 31 on the inner wall of the mounting hole 31 can effectively prevent the installed yarn conductive wire 1 from being pulled out.

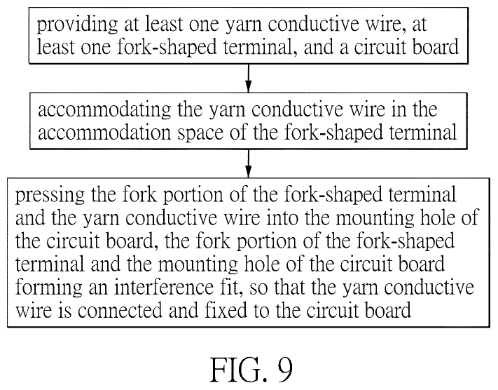

Referring to FIG. 9, the present disclosure further provides a quick connection method for a yarn conductive wire and a circuit board, which includes the following steps.

First, at least one yarn conductive wire 1, at least one fork-shaped terminal 2, and a circuit board 3 are provided (as shown in FIG. 1 to FIG. 8). The structures of the yarn conductive wire 1, the fork-shaped terminal 2, and the circuit board 3 are the same as those in the above-mentioned embodiment, and will not be reiterated herein.

Then, the yarn conductive wire 1 can be inserted into the channel 51 of the jig 5, such that the yarn conductive wire 1 originally arranged horizontally can be arranged vertically in each of the channels 51 of the jig 5, and then the fork-shaped terminals 2 can be pressed in the channel 51. Accordingly, the yarn conductive wire 1 is accommodated in the accommodation space 22 of the fork-shaped terminal 2, and the yarn conductive wire 1 is covered by the fork portion 21 of the fork-shaped terminal 2.

Afterwards, the fork portion 21 of the fork-shaped terminal 2 and the yarn conductive wire 1 are pressed into the mounting hole 31 of the circuit board 3. An interference fit is formed between the fork portion 21 of the fork-shaped terminal 2 and the mounting hole 31 of the circuit board 3. By using the guiding of the fork-shaped terminal 2 and the friction force on the outside the fork-shaped terminal 2, pressing the fork portion 21 into the mounting hole 31 is smooth and pulling the fork portion 21 out of the mounting hole 31 is difficult. An adhesive can also be further dispensed between the fork-shaped terminal 2 and the circuit board 3 for fixing the fork-shaped terminal 2 and the circuit board 3 together.

Finally, the material tape 23 of the entire row of fork-shaped terminals 2 is removed along the break line 24 of the fork-shaped terminal 2. The friction force exerted by the expansion force of the fork-shaped terminal 2 remaining in the mounting hole 31 on the inner wall of the mounting hole 31 can effectively prevent the installed yarn conductive wire 1 from being pulled out. In this way, the connection and fixing of the yarn conductive wire 1 and the circuit board 3 can be completed, and the yarn conductive wire 1 and the circuit board 3 are electrically connected and can be used for electrical signal transmission.

### Beneficial Effects of the Embodiments

In conclusion, in the quick connection structure and the quick connection method for a yarn conductive wire and a circuit board provided by the present disclosure, the quick connection structure includes at least one yarn conductive wire, at least one fork-shaped terminal, and a circuit board. One end of the fork-shaped terminal has a fork portion, an accommodation space is defined in the fork portion, at least one mounting hole is formed on the circuit board, and a wire diameter of the yarn conductive wire is smaller than a diameter of the mounting hole. The yarn conductive wire is accommodated in the accommodation space of the fork-shaped terminal, the fork portion of the fork-shaped terminal and the yarn conductive wire are pressed into the mounting hole of the circuit board, and the fork portion of the terminal and the mounting hole of the circuit board form an interference fit, so that the yarn conductive wire is connected and fixed to the circuit board. Accordingly, by the guiding of the fork-shaped terminal and friction force at the outer side of the fork-shaped terminal, pressing the fork portion into the mounting hole is smooth and pulling the fork portion out of the mounting hole is difficult. That is, the fork-shaped terminal that remains in the mounting hole exerts a force of expansion providing a friction force to an inner wall of the mounting hole, thereby effectively preventing the yarn conductive wire from being pulled out.

The quick connection structure and the quick connection method for a yarn conductive wire and a circuit board provided by the present disclosure can connect and fix the yarn conductive wire and the circuit board in a quick and simple assembly without using solder and be environmentally-friendly. Furthermore, the quick connection structure and method can be used to process materials that are not resistant to high temperature, and can achieve effects of convenient and fast for being used in mass production.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A quick connection structure, comprising:
at least one yarn conductive wire;
at least one fork-shaped terminal, wherein one end of the fork-shaped terminal has a fork portion, the fork portion is bifurcated, and an accommodation space is defined in the fork portion; and
a circuit board, wherein at least one mounting hole is formed on the circuit board, the mounting hole penetrates two opposite sides of the circuit board, and a wire diameter of the yarn conductive wire is smaller than a diameter of the mounting hole;
wherein the yarn conductive wire is accommodated in the accommodation space of the fork-shaped terminal, the fork portion of the fork-shaped terminal and the yarn conductive wire are pressed into the mounting hole of the circuit board, and the fork portion of the terminal and the mounting hole of the circuit board form an interference fit; wherein the yarn conductive wire is clamped in the fork portion of the fork-shaped terminal, so that the yarn conductive wire is connected and fixed to the circuit board.

2. The quick connection structure according to claim 1, wherein the fork portion is connected to a material tape, and a break line is disposed between the fork portion and the material tape.

3. The quick connection structure according to claim 1, wherein a width of the accommodation space tapers inward, a guide portion is formed at one end of the fork portion, a width of the guide portion is smaller than a width of the fork portion, and the guide portion is rounded.

4. The quick connection structure according to claim 1, wherein the diameter of the mounting hole ranges from 0.7 mm to 1.1 mm, and the wire diameter of the yarn conductive wire ranges from 0.3 mm to 0.6 mm.

5. The quick connection structure according to claim 1, wherein the yarn conductive wire is plural in quantity, and the plurality of yarn conductive wires are arranged horizontally; wherein the plurality of yarn conductive wires are sheathed into a channel of a jig beforehand, so that the plurality of yarn conductive wires originally arranged horizontally are arranged vertically; wherein the fork-shaped terminal is pressed into the jig, so that the plurality of yarn conductive wires in the channel are covered by the fork portion of the fork-shaped terminal.

6. A quick connection method for a yarn conductive wire and a circuit board, comprising processes of:
providing at least one yarn conductive wire, at least one fork-shaped terminal, and a circuit board, wherein one end of the fork-shaped terminal has a fork portion, the fork portion is bifurcated, and an accommodation space is defined in the fork portion; wherein at least one mounting hole is formed on the circuit board, the mounting hole penetrates two opposite sides of the circuit board, and a wire diameter of the yarn conductive wire is smaller than a diameter of the mounting hole;
accommodating the yarn conductive wire in the accommodation space of the fork-shaped terminal; and
pressing the fork portion of the fork-shaped terminal and the yarn conductive wire into the mounting hole of the circuit board, so that the fork portion of the fork-shaped terminal and the mounting hole of the circuit board form an interference fit; wherein the yarn conductive wire is clamped in the fork portion of the fork-shaped terminal, so that the yarn conductive wire is connected and fixed to the circuit board.

7. The quick connection method according to claim 6, wherein the fork portion is connected to a material tape, and a break line is disposed between the fork portion and the material tape; wherein, after the fork portion and the yarn conductive wire are pressed into the mounting hole of the circuit board, the fork portion and the material tape are separated by breaking along the break line.

8. The quick connection method according to claim 6, wherein a width of the accommodation space tapers inward, a guide portion is formed at one end of the fork portion, a width of the guide portion is smaller than a width of the fork portion, and the guide portion is rounded and is capable of guiding the fork portion of the fork-shaped terminal to be inserted into the mounting hole of the circuit board.

9. The quick connection method according to claim 6, wherein the diameter of the mounting hole ranges from 0.7 mm to 1.1 mm, and the wire diameter of the yarn conductive wire ranges from 0.3 mm to 0.6 mm.

10. The quick connection method according to claim 6, wherein the yarn conductive wire is plural in quantity, and the plurality of yarn conductive wires are arranged horizontally; wherein the plurality of yarn conductive wires are sheathed into a channel of a jig beforehand, so that the plurality of yarn conductive wires originally arranged horizontally are arranged vertically; wherein the fork-shaped terminal is pressed into the jig, so that the plurality of yarn conductive wires in the channel are covered by the fork portion of the fork-shaped terminal.
